(19) United States
(12) Patent Application Publication
(10) Pub. No.: US 2020/0286005 A1
(43) Pub. Date: Sep. 10, 2020

(54) RIDESHARE VEHICLE UTILIZATION SUPPORTING SYSTEM AND RIDESHARE VEHICLE UTILIZATION SUPPORTING METHOD

(71) Applicant: HONDA MOTOR CO., LTD., Tokyo (JP)

(72) Inventors: Isao Uematsu, Wako-shi (JP); Kuniaki Matsushima, Wako-shi (JP); Kenichi Kobayashi, Wako-shi (JP)

(21) Appl. No.: 16/800,930

(22) Filed: Feb. 25, 2020

(30) Foreign Application Priority Data
Mar. 5, 2019 (JP) 2019-039316

(51) Int. Cl. G06Q 10/02; G01C 21/36; G06Q 50/30; G06Q 10/06

(52) U.S. Cl. CPC G06Q 10/02; G01C 21/3667; G06F 3/0488; G06Q 10/06315; G06Q 2240/00; G06Q 50/30

(57) ABSTRACT

A rideshare vehicle utilization supporting system supports matching of a rideshare vehicle and a user. The rideshare vehicle utilization supporting system includes: a rideshare vehicle management unit that manages a ridesharing plan of the rideshare vehicle within a retrieval target area; a predetermined rideshare vehicle extraction unit that extracts a predetermined rideshare vehicle, the predetermined rideshare vehicle being the rideshare vehicle for which the ridesharing plan within the retrieval target area in a retrieval target time zone is already determined by the rideshare vehicle management unit; and a predetermined ridesharing route guide unit that makes a display unit visually recognized by the user display a predetermined ridesharing route guide screen for which a predetermined ridesharing route of the predetermined rideshare vehicle is superimposed on a map of the retrieval target area.

### INCORPORATION BY REFERENCE

The present application claims priority under 35 U.S.C. § 119 to Japanese Patent Application No. 2019-039316 filed on Mar. 5, 2019. The content of the application is incorporated herein by reference in its entirety.

### BACKGROUND OF THE INVENTION

### Field of the Invention

The present invention relates to a rideshare vehicle utilization supporting system and a rideshare vehicle utilization supporting method.

### Description of the Related Art

Conventionally, an automobile ridesharing supporting system that retrieves a ridesharing desiring person who is suited to a drive schedule of a rideshare vehicle set by a driver of the rideshare vehicle and matches the rideshare vehicle and the ridesharing desiring person has been proposed (for example, see Japanese Patent Laid-Open No. 2002-140399).

In the above-described automobile ridesharing supporting system, rideshare vehicle utilization conditions (a departure place, a destination, a departure time) desired by the ridesharing desiring person are preserved in a ridesharing desire management table, and the ridesharing desiring person suited to the drive schedule of the rideshare vehicle is retrieved with reference to the ridesharing desire management table.

As in the system described in Japanese Patent Laid-Open No. 2002-140399 described above, when the ridesharing desiring person suited to the drive schedule of the rideshare vehicle is retrieved, there is a case where an appropriate rideshare vehicle is not matched. Then, in this way, since the appropriate rideshare vehicle is not matched, a user who could not utilize the rideshare vehicle loses a desire to utilize the rideshare vehicle, and there is a risk that acceleration of rideshare vehicle utilization is obstructed as a result.

An aspect of the present invention is implemented in consideration of such a background, with an object of providing a rideshare vehicle utilization supporting system and a rideshare vehicle utilization supporting method capable of improving a matching rate of rideshare vehicles and users.

### SUMMARY OF THE INVENTION

A configuration for achieving the above-described object may be, for example, a rideshare vehicle utilization supporting system that supports matching of a rideshare vehicle and a user who desires to utilize the rideshare vehicle, the rideshare vehicle utilization supporting system including: a rideshare vehicle management unit that manages a ridesharing plan of the rideshare vehicle within a prescribed retrieval target area; a predetermined rideshare vehicle extraction unit that extracts a predetermined rideshare vehicle, the predetermined rideshare vehicle being the rideshare vehicle for which the ridesharing plan within the retrieval target area in a prescribed retrieval target time zone is already determined by the rideshare vehicle management unit; and a predetermined ridesharing route guide unit that makes a display unit visually recognized by the user display a predetermined ridesharing route guide screen for which a predetermined ridesharing route of the predetermined rideshare vehicle is superimposed on a map of the retrieval target area.

In the above-described rideshare vehicle utilization supporting system, the predetermined rideshare vehicle extraction unit may be configured to extract only the predetermined rideshare vehicle which is the rideshare vehicle with a vacant seat remaining.

The above-described rideshare vehicle utilization supporting system may be configured to include: a desired get-on time recognition unit that recognizes a desired time for the user to get on the rideshare vehicle; and a retrieval target time zone setting unit that sets a prescribed time zone including the desired get-on time as the retrieval target time zone.

The above-described rideshare vehicle utilization supporting system may be configured to include a retrieval target time zone setting unit that sets the retrieval target time zone according to a specification of the user.

The above-described rideshare vehicle utilization supporting system may be configured to include a desired get-on/get-off spot recognition unit that recognizes a desired get-on spot to the rideshare vehicle and a desired get-off spot from the rideshare vehicle for the user, and the predetermined rideshare vehicle extraction unit may be configured to extract only the predetermined rideshare vehicle which is the rideshare vehicle for which getting on in a prescribed get-on area including the desired get-on spot is possible and also getting off in a prescribed get-off area including the desired get-off spot is possible.

The above-described rideshare vehicle utilization supporting system may be configured to include a desired use condition recognition unit that recognizes a desired use condition including a use condition of a compartment of the rideshare vehicle or a condition of a passenger of the rideshare vehicle desired by the user, and the predetermined rideshare vehicle extraction unit may be configured to extract only the predetermined rideshare vehicle which is the rideshare vehicle coinciding with the desired use condition.

In the above-described rideshare vehicle utilization supporting system, the predetermined ridesharing route guide unit may be configured to make the display unit display the predetermined ridesharing route guide screen displaying a reservation status display portion indicating a count of established reservations or a reservation establishment degree of the rideshare vehicle in the retrieval target area for each time zone.

Another configuration for achieving the above-described object may be, for example, a rideshare vehicle utilization supporting method executed by a computer to support matching of a rideshare vehicle and a user who desires to utilize the rideshare vehicle, and the rideshare vehicle utilization supporting method includes: a rideshare vehicle management step in which the computer manages a ridesharing plan of the rideshare vehicle within a prescribed retrieval target area; a predetermined rideshare vehicle extraction step in which the computer extracts a predetermined rideshare vehicle, the predetermined rideshare vehicle being the rideshare vehicle for which the ridesharing plan within the retrieval target area in a prescribed retrieval target time zone is already determined by the rideshare vehicle management step; and a predetermined ridesharing route guide step in which the computer makes a display unit visually recognized by the user display a predetermined ridesharing route guide screen for which a predetermined ridesharing route of the predetermined rideshare vehicle is superimposed on a map of the retrieval target area.

According to the above-described rideshare vehicle utilization supporting system, a rideshare vehicle management unit manages a ridesharing plan of a rideshare vehicle within a retrieval target area. In addition, a predetermined rideshare vehicle extraction unit extracts a predetermined rideshare vehicle, which is the rideshare vehicle for which the ridesharing plan within the retrieval target area in a prescribed retrieval target time zone is already determined by the rideshare vehicle management unit. Then, a predetermined ridesharing route guide unit makes a display unit visually recognized by the user display a predetermined ridesharing route guide screen for which a predetermined ridesharing route of the predetermined rideshare vehicle is superimposed on a map of the retrieval target area. The user can recognize a route of the predetermined rideshare vehicle already determined to travel in the retrieval target time zone by visually recognizing the predetermined ridesharing route guide screen. Then, the user selects the predetermined rideshare vehicle for which the ridesharing route passing through a get-on spot and a get-off spot desired by the user or the vicinity is set among the predetermined rideshare vehicles, whereby the user can improve a matching probability with the rideshare vehicle in accordance with his/her own desire. A similar operation effect can be obtained by the above-described rideshare vehicle utilization supporting method as well.

### BRIEF DESCRIPTION OF THE DRAWINGS

FIG. 1 is an explanatory drawing of matching of a user and a rideshare vehicle by a rideshare vehicle utilization supporting system;

FIG. 2 is a configuration diagram of the rideshare vehicle utilization supporting system;

FIG. 3 is an explanatory drawing of a reservation database;

FIG. 4 is an explanatory drawing of matching processing of the user and the rideshare vehicle; and

FIG. 5 is an explanatory drawing of a predetermined ridesharing route guide screen.

### DETAILED DESCRIPTION OF THE PREFERRED EMBODIMENTS

### 1. Aspect of Matching by Rideshare Vehicle Utilization Supporting System

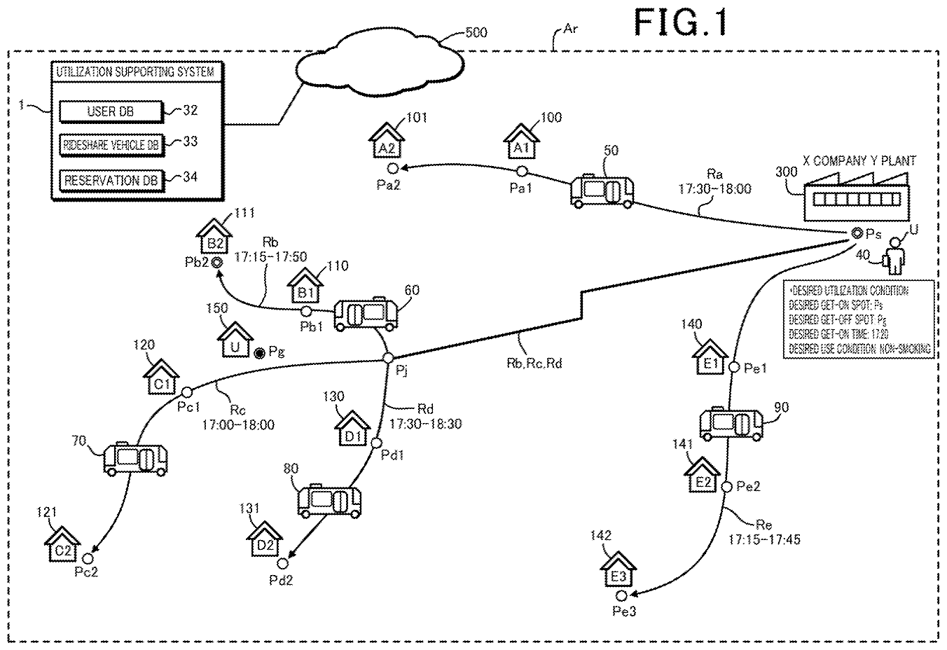

With reference to FIG. 1, an aspect of matching of a user and a rideshare vehicle by a rideshare vehicle utilization supporting system 1 (shortened and described as a utilization supporting system 1, hereinafter) of the present embodiment will be described. FIG. 1 illustrates a case where the utilization supporting system 1 proposes matching with rideshare vehicles 50, 60, 70, 80 and 90, a ridesharing plan of which is already determined, to a user U who desires to reserve a rideshare vehicle for moving within an area Ar.

The utilization supporting system 1 provides a service of proposing matching to a user and a rideshare vehicle registered to utilize the utilization supporting system 1. Information of the user is recorded in a user DB (database) 32, and information of the rideshare vehicle is recorded in a rideshare vehicle DB 33. In addition, reservation information of the rideshare vehicle is recorded in a reservation DB 34. The rideshare vehicle may be not only a shared vehicle by so-called ridesharing but also a shared vehicle by carsharing or a taxi or the like.

In an example in FIG. 1, a situation where employees of a Y plant 300 (shortened and described as a plant 300, hereinafter) of an X company go home to their own houses by utilizing the rideshare vehicles 50, 60, 70, 80 and 90 is shown. Signs 100, 101, 110, 111, 120, 121, 130, 131, 140, 141 and 142 in FIG. 1 respectively denote the houses of users A1, A2, B1, B2, C1, C2, D1, D2, E1, E2 and E3 of the utilization supporting system 1, who are the employees of the plant 300.

For the rideshare vehicle 50, a ridesharing plan of traveling a route Ra from a location spot Ps of the plant 300 via a location spot Pa1 of the house 100 of the user A1 to a location spot Pa2 of the house 101 of the user A2 by a schedule of 17:30-18:00 is determined. For the rideshare vehicle 60, a ridesharing plan of traveling a route Rb from the location spot Ps of the plant 300 via a location spot Pb1 of the house 110 of the user B1 to a location spot Pb2 of the house 111 of the user B2 by the schedule of 17:15-17:50 is determined.

For the rideshare vehicle 70, a ridesharing plan of traveling a route Rc from the location spot Ps of the plant 300 via a location spot Pc1 of the house 120 of the user C1 to a location spot Pc2 of the house 121 of the user C2 by the schedule of 17:00-18:00 is determined. For the rideshare vehicle 80, a ridesharing plan of traveling a route Rd from the location spot Ps of the plant 300 via a location spot Pd1 of the house 130 of the user D1 to the house 131 of the user D2 by the schedule of 17:30-18:30 is determined. For the rideshare vehicle 90, a ridesharing plan of traveling a route Re from the location spot Ps of the plant 300 via a location spot Pe1 of the house 140 of the user E1 and a location spot Pe2 of the house 141 of the user E2 to a location spot Pe3 of the house 142 of the user E3 by the schedule of 17:15-17:45 is determined.

The user U illustrated in FIG. 1 is an employee of the plant 300, and is already registered to utilize the utilization supporting system 1. The user U has a user terminal 45, and is about to reserve a rideshare vehicle for going home to a house 150. By executing a ridesharing matching application provided from the utilization supporting system 1 in the user terminal 45, the user U communicates with the utilization supporting system 1, and enjoys a rideshare vehicle utilization supporting service by the utilization supporting system 1.

The utilization supporting system 1 refers to the reservation DB 34, and extracts a predetermined rideshare vehicle suited to a desired utilization condition of the user U, from the rideshare vehicles, the ridesharing plan of which is already determined. Then, the utilization supporting system 1 transmits, to the user terminal 45, data of a predetermined ridesharing route guide screen (details will be described later) indicating a scheduled traveling route (predetermined ridesharing route) by the ridesharing plan of the predetermined rideshare vehicle superimposed on a map of the area Ar.

The user U can visually recognize the predetermined ridesharing route guide screen displayed at a display unit of the user terminal 45, select one of the predetermined rideshare vehicles, the ridesharing plan of which is already determined, and apply for a reservation. In the example in FIG. 1, the user U can confirm the predetermined ridesharing routes Ra, Rb, Rc, Rd and Re of the rideshare vehicles 50, 60, 70, 80 and 90 that are the predetermined rideshare vehicles, and select the rideshare vehicle from which getting off at a spot near a desired get-off spot Pg is possible, from the rideshare vehicles 50, 60, 70, 80 and 90.

In this way, by proposing matching with the rideshare vehicles 50, 60, 70, 80 and 90, the ridesharing plan of which is already determined, to the user U, a matching rate is expected to be improved compared to the case of newly retrieving a rideshare vehicle, creating a ridesharing plan and making an arrangement.

### 2. Configuration of Rideshare Vehicle Utilization Supporting System

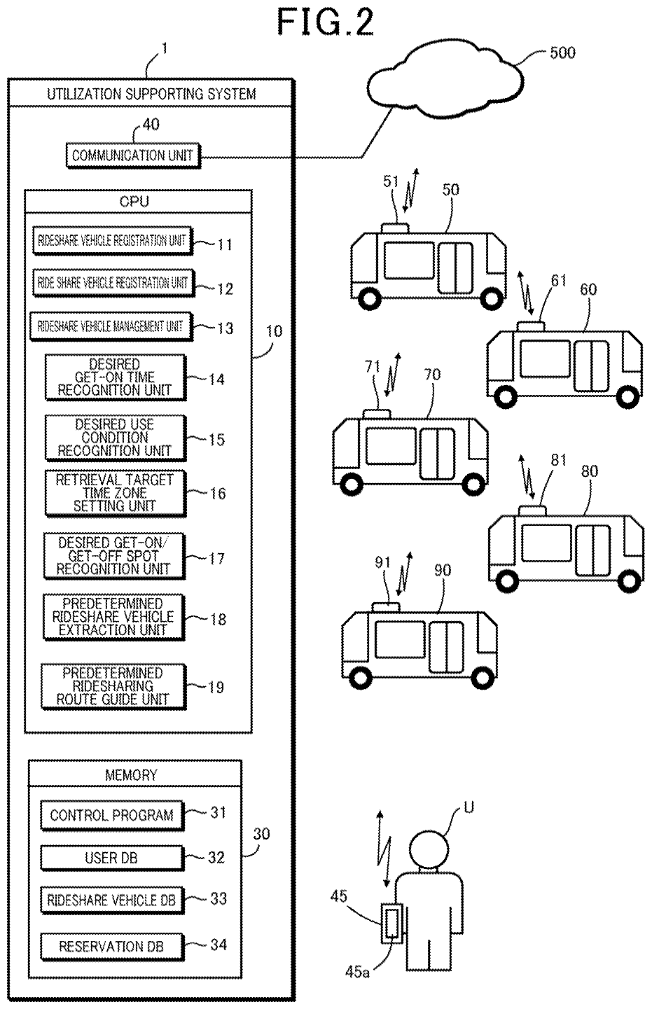

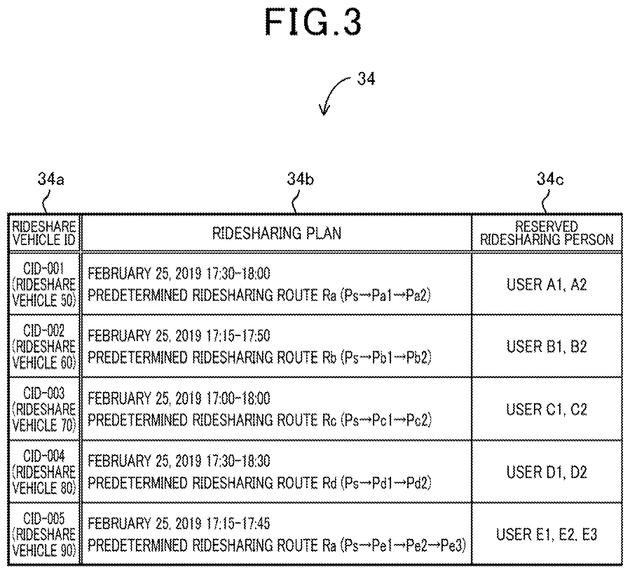

With reference to FIG. 2 and FIG. 3, the configuration of the utilization supporting system will be described. With reference to FIG. 2, the utilization supporting system 1 is a computer system configured by a CPU (Central Processing Unit) 10, a memory 30, and a communication unit 40 or the like. By the communication unit 40, the utilization supporting system 1 communicates, via the communication network 500, with a vehicle controller 51 of the rideshare vehicle 50, a vehicle controller 61 of the rideshare vehicle 60, a vehicle controller 71 of the rideshare vehicle 70, a vehicle controller 81 of the rideshare vehicle 80, a vehicle controller 91 of the rideshare vehicle 90, and the user terminal 45 used by the user U.

In the memory 30, in addition to the user DB 32, the rideshare vehicle DB 33, and the reservation DB 34 described above, a control program 31 of the utilization supporting system 1 is preserved. By reading and executing the control program 31 preserved in the memory 30, the CPU 10 functions as a rideshare vehicle registration unit 11, a user registration unit 12, a rideshare vehicle management unit 13, a desired get-on time recognition unit 14, a desired use condition recognition unit 15, a retrieval target time zone setting unit 16, a desired get-on/get-off spot recognition unit 17, a predetermined rideshare vehicle extraction unit 18, and a predetermined ridesharing route guide unit 19.

Here, processing executed by the rideshare vehicle management unit 13 corresponds to a rideshare vehicle management step in the rideshare vehicle utilization supporting method of the present invention, and processing executed by the predetermined rideshare vehicle extraction unit 18 corresponds to a predetermined rideshare vehicle extraction step in the rideshare vehicle utilization supporting method of the present invention. In addition, processing executed by the predetermined ridesharing route guide unit 19 corresponds to a predetermined ridesharing route guide step in the rideshare vehicle utilization supporting method of the present invention.

The rideshare vehicle registration unit 11 registers the rideshare vehicle to the utilization supporting system 1. The rideshare vehicle is registered by recording the information of the rideshare vehicle in the rideshare vehicle DB 33. As the information of the rideshare vehicle, the rideshare vehicle registration unit 11 records a rideshare vehicle ID (identification) issued to the rideshare vehicle, a model of the rideshare vehicle, a riding capacity, a utilization cost, a utilizable period and the like in the rideshare vehicle DB 33.

The user registration unit 12 registers the user to the utilization supporting system 1. The user is registered by recording the information of the user in the user DB 32. As the information of the user, the user registration unit 12 records a user ID issued to the user, a name of the user, a home address, workplace information (a company name, a location, a belonging department and the like) in the user DB 32.

The rideshare vehicle management unit 13 creates the ridesharing plan based on a reservation status for the rideshare vehicle recorded in the rideshare vehicle DB 33, and records the plan in the reservation DB 34. As illustrated in FIG. 3, in the reservation DB 34, information of a rideshare vehicle ID 34a, a ridesharing plan 34b, and a reserved ridesharing person 34c is recorded for each rideshare vehicle. FIG. 3 illustrates the reservation status of the rideshare vehicles 50, 60, 70, 80 and 90 according to the situation in FIG. 1. For example, for the rideshare vehicle 50, CID-001 is recorded in the rideshare vehicle ID 34a, and the ridesharing plan of traveling the ridesharing route Ra (Ps→Pa1→Pa2) from 17:30 to 18:00 on Feb. 25, 2019 is recorded in the ridesharing plan 34b. In addition, the users A1 and A2 are recorded in the reserved ridesharing person 34c.

The desired get-on time recognition unit 14 recognizes a desired time for the user U to get on the rideshare vehicle, based on desired get-on time information transmitted from the user terminal 45. The desired use condition recognition unit 15 recognizes a desired use condition of the user U for the rideshare vehicle, based on desired use condition information transmitted from the user terminal 45. The desired use condition includes a use condition of a compartment of the rideshare vehicle (such as non-smoking) and a condition of a passenger (such as women only) or the like.

The retrieval target time zone setting unit 16 sets a prescribed time zone including the desired get-on time (for example, one hour between the hours before and after the desired get-on time) as a retrieval target time zone. Note that the retrieval target time zone may be specified by an operation of the user terminal 45 by the user U. The desired get-on/get-off spot recognition unit 17 recognizes a desired get-on spot and a desired get-off spot of the user U for the rideshare vehicle, based on desired get-on/get-off information transmitted from the user terminal 45.

The predetermined rideshare vehicle extraction unit 18 sets an area including the desired get-on spot and the desired get-off spot of the user U as a retrieval target area of the rideshare vehicle to be matched with the user U. The rideshare vehicle of a matching candidate travels the ridesharing route set within the retrieval target area. In FIG. 1, the area Ar is set as the retrieval target area.

The predetermined ridesharing route guide unit 19 transmits, to the user terminal 45, the data of the predetermined ridesharing route guide screen displaying the route of the rideshare vehicle of the matching candidate extracted by the predetermined rideshare vehicle extraction unit 18 superimposed on the map of the retrieval target area. The user U can confirm the predetermined ridesharing route guide screen displayed at a display unit 45a of the user terminal 45, select a desired rideshare vehicle from the rideshare vehicles, the ridesharing plan of which is already determined, and apply for a reservation. Details of the predetermined ridesharing route guide screen will be described later.

### 3. Matching Processing of Rideshare Vehicle with User

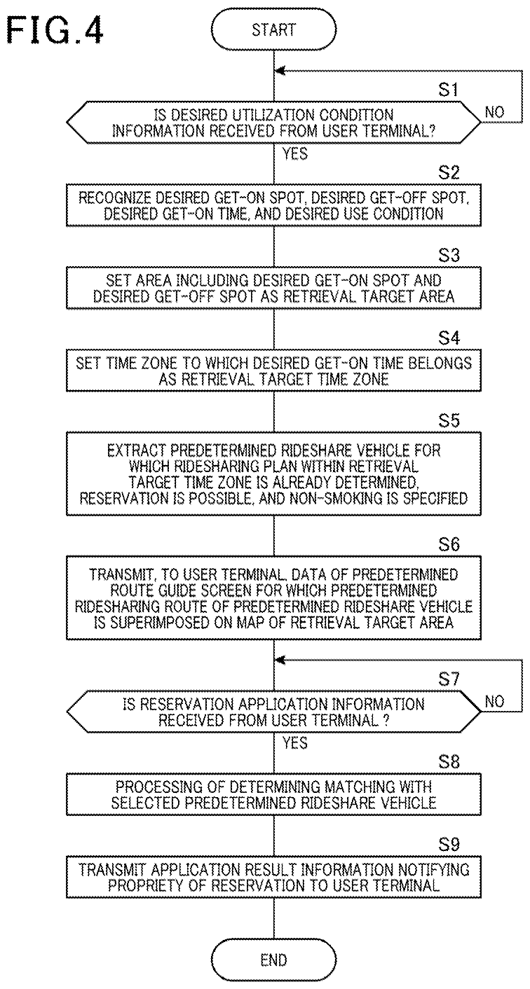

According to a flowchart illustrated in FIG. 4, in the situation illustrated in FIG. 1, matching processing of the rideshare vehicle with the user U executed by the utilization supporting system 1 will be described. In step S1 in FIG. 4, when desired get-on condition information indicating a desired get-on condition is received from the user terminal 45, the utilization supporting system 1 advances the processing to step S2.

The desired get-on condition includes the desired get-on time information, the desired get-on/get-off spot information, and the desired use condition information described above. In step S2, the desired get-on time recognition unit 14 recognizes the desired time for the user U to get on the rideshare vehicle from the desired get-on time information. In addition, the desired get-on/get-off spot recognition unit 17 recognizes the desired get-on spot to the rideshare vehicle for the user U and the desired get-off spot from the rideshare vehicle for the user U, from the desired get-on/get-off spot information. Further, the desired use condition recognition unit 15 recognizes the rideshare vehicle use condition of the user U from the desired use condition information.

Here, as illustrated in FIG. 1, it is recognized that the desired get-on spot for the user U is Ps (the location spot of the Y plant 300 of the X company), the desired get-off spot is Pg (the location spot of the house 150 of the user U), the desired get-on time is 17:20, and the use condition of the rideshare vehicle is non-smoking. In following step S3, the predetermined rideshare vehicle extraction unit 18 sets the area Ar including the desired get-on spot Ps and the desired get-off spot Pg as the retrieval target area of the rideshare vehicle to be matched with the user U.

In following step S4, the retrieval target time zone setting unit 16 sets a time zone from the hour 17:00 immediately before the desired get-on time 17:20 for the user U to the hour 18:00 immediately after as the retrieval target time zone. In following step S5, the predetermined rideshare vehicle extraction unit 18 extracts the predetermined rideshare vehicle for which the ridesharing plan of starting movement on the ridesharing route within the retrieval target time zone (here, 17:00-18:00) is already determined, a reservation is possible, and non-smoking is set as the use condition. In the example in FIG. 1, it is assumed that the rideshare vehicle 50 (the ridesharing plan in 17:30-18:00), the rideshare vehicle 60 (the ridesharing plan in 17:15-17:50), the rideshare vehicle 70 (the ridesharing plan in 17:00-18:00), the rideshare vehicle 80 (the ridesharing plan in 17:30-18:30), and the rideshare vehicle 90 (17:15-17:45) are extracted as the predetermined rideshare vehicles and description is given below.

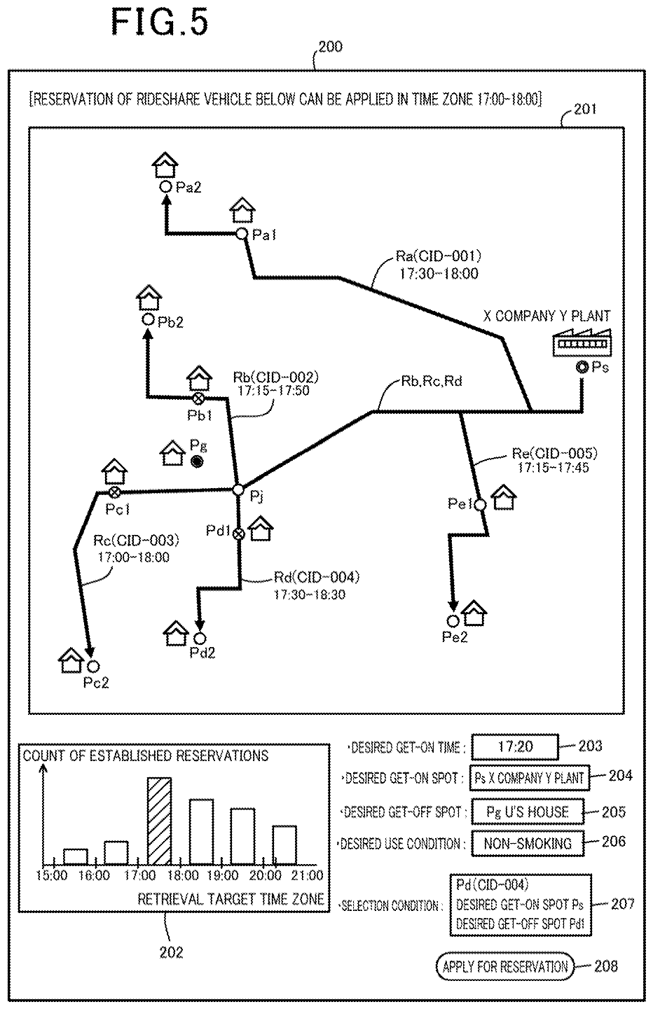

In following step S6, the predetermined ridesharing route guide unit 19 transmits, to the user terminal 45, the data of the predetermined ridesharing route guide screen displaying the predetermined ridesharing route which is a moving route of the predetermined rideshare vehicle superimposed on the map of the area Ar. Here, with reference to FIG. 5, the predetermined ridesharing route guide screen will be described. A predetermined ridesharing route guide screen 200 illustrated in FIG. 5 corresponds to the situation in FIG. 1, and displays a predetermined ridesharing route map 201 in which predetermined ridesharing routes Ra, Rb, Rc, Rd and Re of the predetermined rideshare vehicles 50, 60, 70, 80 and 90 are superimposed on the map of the area Ar. On the predetermined ridesharing route map 201, the travel scheduled time and the get-on/get-off spots of the respective predetermined ridesharing routes are illustrated.

In addition, the predetermined ridesharing route guide screen 200 displays a rideshare vehicle desired get-on time input column 203, a rideshare vehicle desired get-on spot input column 204, a rideshare vehicle desired get-off spot input column 205, and a desired use condition input column 206. The user U inputs the utilization condition of the rideshare vehicle to the input columns 203-206, and thus the utilization condition information is transmitted to the utilization supporting system 1. In the example in FIG. 5, by receiving the information of the desired get-off spot Pg, the predetermined ridesharing route guide unit 19 emphatically displays (displays with x in FIG. 5) the get-off spots Pb1, Pc1 and Pd1 near the desired get-off spot Pg, and improves visibility by the user U.

Further, the predetermined ridesharing route guide screen 200 displays an input column 207 for a rideshare vehicle selection condition. The user U selects the desired ridesharing route, the desired get-on spot and the desired get-off spot from the predetermined ridesharing routes Ra, Rb, Rc, Rd and Re displayed on the predetermined ridesharing route map 201. The user U selects the predetermined ridesharing route by touching one of the predetermined ridesharing routes displayed on the predetermined ridesharing route map 201. In addition, the user U selects the desired get-on spot and the desired get-off spot by touching the get-on/get-off spots in the selected predetermined ridesharing route. FIG. 5 illustrates the case where the user U selects the predetermined ridesharing route Pd of the rideshare vehicle 80 (the vehicle ID is CID-004), selects Ps (the location spot of the Y plant of the X company) as the desired get-on spot, and selects Pd1 (the location spot of the house of the user D1) as the desired get-off spot.

Further, the predetermined ridesharing route guide screen 200 displays a reservation status graph 202 (corresponding to a reservation status display portion of the present invention) displaying a count of established reservations for each time zone. The reservation status graph is illustrated by setting hourly time zones (15:00-16:00, 16:00-17:00, . . . ) on a horizontal axis and setting a count of ridesharing already established in each time zone (corresponding to a reservation establishment degree of the present invention) on a vertical axis. In FIG. 5, the retrieval target time zone 17:00-18:00 set by the retrieval target time zone setting unit 16 is illustrated with oblique lines.

By confirming the reservation status graph, the user U can change the desired get-on time to a time zone in which a reservation may be made, and in accordance with the change of the desired get-on time, the predetermined rideshare vehicle is extracted again by the predetermined rideshare vehicle extraction unit 18. Then, the predetermined ridesharing route guide unit 19 transmits, to the user terminal 45, the data of the predetermined ridesharing route guide screen indicating the predetermined ridesharing route of the predetermined rideshare vehicle extracted again. Thus, the matching rate of rideshare vehicles by the user U is expected to be improved.

By the user U touching a reservation applying button 208 displayed on the predetermined ridesharing route guide screen 200, reservation application information indicating a reservation application condition (the predetermined ridesharing route and the vehicle ID of the predetermined rideshare vehicle, the desired get-on spot and the desired get-off spot) inputted in the input column 207 for the rideshare vehicle selection condition is transmitted from the user terminal 45 to the utilization supporting system 1.

In step S7, when the reservation application information is received from the user terminal 45, the rideshare vehicle management unit 13 advances the processing to step S8. In step S8, the rideshare vehicle management unit 13 transmits reservation inquiry information inquiring propriety of the reservation to an operator terminal used by an operator (a driver, a manager or the like) of the predetermined rideshare vehicle selected by the reservation application condition recognized from the reservation application information, and performs processing of determining matching with the user U.

When information of approving the reservation is received from the operator terminal, the rideshare vehicle management unit 13 changes the ridesharing plan of the rideshare vehicle 80, and adds getting on at the spot Ps and getting off at the spot Pd1 of the user U. In addition, when the rideshare vehicle 80 can cope with getting off at the location spot Pg of the house of the user U, the rideshare vehicle management unit 13 changes the ridesharing route of the rideshare vehicle 80 so as to go through the location spot Pg.

In following step S9, the rideshare vehicle management unit 13 transmits, to the user terminal 45, application result information notifying the propriety of the reservation. In the case where the reservation cannot be made, the user U can deal by applying for the reservation of the other rideshare vehicle 60 or rideshare vehicle 70, changing the desired get-on time to change the rideshare vehicle to be a selection target or the like.

### 4. Other Embodiments

In the above-described embodiment, the predetermined rideshare vehicle extraction unit 18 sets the area Ar including the desired get-on spot and the desired get-off spot inputted by the user U as the retrieval target area, however, the retrieval target area may be set by other conditions. For example, an area including the location spot of the house of the user U and the location spot of the workplace of the user U recorded in the user DB 32 may be set as the retrieval target area. Or, an area of a prescribed range (such as an area within a radius of several tens kilometers) with the location spot of the house of the user U at a center may be set as the retrieval target area.

In the above-described embodiment, as illustrated in FIG. 5, the reservation status graph 202 indicating a count of establishments as the establishment degree of the reservation for each time zone is displayed on the predetermined ridesharing route guide screen 200, however, display of the reservation status graph 202 may be omitted. Or, not the count of the reservations but a ratio of the count of the establishments to the count of reservation applications may be displayed.

In the above-described embodiment, the predetermined rideshare vehicle extraction unit 18 extracts only the predetermined rideshare vehicle which is the rideshare vehicle with a vacant seat remaining, however, the limitation may not be performed.

In the above-described embodiment, the predetermined rideshare vehicle extraction unit 18 extracts only the predetermined rideshare vehicle which is the rideshare vehicle coinciding with the desired use condition of the user U recognized by the desired use condition recognition unit 15, however, the limitation may not be performed.

In the above-described embodiment, the predetermined rideshare vehicle extraction unit 18 may extract only the predetermined rideshare vehicle which is the rideshare vehicle for which getting on in a prescribed get-on area including the desired get-on spot of the user U is possible and also getting off in a prescribed get-off area including the desired get-off spot of the user U is possible.

In the above-described embodiment, the case of supporting utilization of the rideshare vehicle with the user who leaves the plant 300 and goes home as a target is described as an example, however, a situation to which the present invention is applicable is not limited to the case, and the present invention is applicable to various ridesharing situations as below for example.

<Ridesharing Route>

As illustrated in FIG. 1, the ridesharing route may be not only the ridesharing route of successively picking up the plurality of users on the way and going to a common destination but also the ridesharing route that the plurality of users get on the rideshare vehicle at a common departure place and traveling is performed via the desired get-off spot of each user. For example, in the example in FIG. 1, the ridesharing route corresponds to the ridesharing route that the plurality of users get on the rideshare vehicle at the plant 300 in the time zone of leaving work and the rideshare vehicle successively stops near the house of each user. Further, the ridesharing route may be the ridesharing route of going back and forth between a plurality of event sites or between an event site and a nearest station.

<Destination and Departure Place of Movement by Ridesharing>

The destination and the departure place of movement by ridesharing may be not only a company facility such as the plant 300 illustrated in FIG. 1 but also a public facility such as a station or a shopping center, a tourist site, a sports stadium, a concert site, and the like. Further, the destination and the departure place of the movement by ridesharing may be not only one spot but also a prescribed area including a plurality of spots. For example, the destination or the departure place of the movement by ridesharing may be a prescribed area where a plurality of company facilities exist. In this case, the plurality of users working in the different company facilities ride together in the rideshare vehicle near the houses and move to working facilities within the prescribed area, or get on the rideshare vehicle at the working facilities within the prescribed area and move to the vicinity of the houses.

Note that FIG. 2 is a schematic drawing illustrating a functional configuration of the rideshare vehicle utilization supporting system 1 in divisions depending on main processing content, in order to easily understand the claimed invention, and the configuration of the rideshare vehicle utilization supporting system 1 may be configured by other divisions. In addition, the processing of each component may be executed by one hardware unit or may be executed by a plurality of hardware units. Further, the processing of each component illustrated in FIG. 2 may be executed by one program or may be executed by a plurality of programs.

### REFERENCE SIGNS LIST

1 . . . rideshare vehicle utilization supporting system, 10 . . . CPU, 11 . . . rideshare vehicle registration unit, 12 . . . user registration unit, 13 . . . rideshare vehicle management unit, 14 . . . desired get-on time recognition unit, 15 . . . desired use condition recognition unit, 16 . . . retrieval target time zone setting unit, 17 . . . desired get-on/get-off spot recognition unit, 18 . . . predetermined rideshare vehicle extraction unit, 19 . . . predetermined ridesharing route guide unit, 30 . . . memory, 31 . . . control program, 32 . . . user DB, 33 . . . rideshare vehicle DB, 34 . . . reservation DB, 40 . . . communication unit, 45 . . . user terminal, 45a . . . display unit, 50, 60, 70, 80, 90 . . . rideshare vehicle (predetermined rideshare vehicle), 51, 61, 71, 81, 91 . . . vehicle controller, 200 . . . predetermined ridesharing route guide screen, 201 . . . predetermined ridesharing route map, 202 . . . reservation status graph, U . . . user, Ra, Rb, Rc, Rd, Re . . . predetermined ridesharing route, Ps . . . desired get-on spot, Pg . . . desired get-off spot.

What is claimed is:

1. A rideshare vehicle utilization supporting system that supports matching of a rideshare vehicle and a user who desires to utilize the rideshare vehicle, the rideshare vehicle utilization supporting system comprising:
a rideshare vehicle management unit that manages a ridesharing plan of the rideshare vehicle within a prescribed retrieval target area;
a predetermined rideshare vehicle extraction unit that extracts a predetermined rideshare vehicle, the predetermined rideshare vehicle being the rideshare vehicle for which the ridesharing plan within the retrieval target area in a prescribed retrieval target time zone is already determined by the rideshare vehicle management unit; and
a predetermined ridesharing route guide unit that makes a display unit visually recognized by the user display a predetermined ridesharing route guide screen for which a predetermined ridesharing route of the predetermined rideshare vehicle is superimposed on a map of the retrieval target area.

2. The rideshare vehicle utilization supporting system according to claim 1,
wherein the predetermined rideshare vehicle extraction unit extracts only the predetermined rideshare vehicle which is the rideshare vehicle with a vacant seat remaining.

3. The rideshare vehicle utilization supporting system according to claim 1, comprising:
a desired get-on time recognition unit that recognizes a desired time for the user to get on the rideshare vehicle; and
a retrieval target time zone setting unit that sets a prescribed time zone including the desired get-on time as the retrieval target time zone.

4. The rideshare vehicle utilization supporting system according to claim 1, comprising
a retrieval target time zone setting unit that sets the retrieval target time zone according to a specification of the user.

5. The rideshare vehicle utilization supporting system according to claim 1, comprising
a desired get-on/get-off spot recognition unit that recognizes a desired get-on spot to the rideshare vehicle and a desired get-off spot from the rideshare vehicle for the user,
wherein the predetermined rideshare vehicle extraction unit extracts only the predetermined rideshare vehicle which is the rideshare vehicle for which getting on in a prescribed get-on area including the desired get-on spot is possible and also getting off in a prescribed get-off area including the desired get-off spot is possible.

6. The rideshare vehicle utilization supporting system according to claim 1, comprising
a desired use condition recognition unit that recognizes a desired use condition including a use condition of a compartment of the rideshare vehicle or a condition of a passenger of the rideshare vehicle desired by the user,
wherein the predetermined rideshare vehicle extraction unit extracts only the predetermined rideshare vehicle which is the rideshare vehicle coinciding with the desired use condition.

7. The rideshare vehicle utilization supporting system according to claim 1,
wherein the predetermined ridesharing route guide unit makes the display unit display the predetermined ridesharing route guide screen displaying a reservation status display portion indicating a count of established reservations or a reservation establishment degree of the rideshare vehicle in the retrieval target area for each time zone.

8. A rideshare vehicle utilization supporting method executed by a computer to support matching of a rideshare vehicle and a user who desires to utilize the rideshare vehicle, the rideshare vehicle utilization supporting method comprising:
a rideshare vehicle management step in which the computer manages a ridesharing plan of the rideshare vehicle within a prescribed retrieval target area;
a predetermined rideshare vehicle extraction step in which the computer extracts a predetermined rideshare vehicle, the predetermined rideshare vehicle being the rideshare vehicle for which the ridesharing plan within the retrieval target area in a prescribed retrieval target time zone is already determined by the rideshare vehicle management step; and
a predetermined ridesharing route guide step in which the computer makes a display unit visually recognized by the user display a predetermined ridesharing route guide screen for which a predetermined ridesharing route of the predetermined rideshare vehicle is superimposed on a map of the retrieval target area.
